(19) United States
(12) Patent Application Publication
(10) Pub. No.: US 2008/0001339 A1
(43) Pub. Date: Jan. 3, 2008

(54) FOLDER

(75) Inventor: Kazushige Tahara, Noda-Shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/770,556

(22) Filed: Jun. 28, 2007

(30) Foreign Application Priority Data
Jun. 30, 2006 (JP) 2006-180694

(51) Int. Cl. B41L 43/04

(52) U.S. Cl. 270/41

(57) ABSTRACT

A folder includes upper and lower tension rollers and the like for transporting web; a cut-off cylinder for cutting off the web from the upper tension rollers; a folding cylinder for holding the forward edge of the web to be cut off by the cut-off cylinder; a first air nozzle, which blows air against the web between the lower tension rollers, and the folding cylinder, so as to force the web towards the outer peripheral surface of the folding cylinder; and a controller, which controls a first on-off valve so that air is blown out from the first air nozzle when an edge portion, on the upstream side in the transporting direction, of the web is located at least between the lower tension rollers, and the folding cylinder.

### BACKGROUND OF THE INVENTION

1. Field of the Invention

The present invention relates to a folder, which cuts off web transported into a sheet, and which then folds the sheet into a signature.

2. Description of the Related Art

FIG. 18 shows an example of a conventional folder, which cuts off web having been transported into a sheet, and which then folds the sheet into a signature.

As shown in FIG. 18, a pair of lower tension rollers 112a, and 112b are arranged below a pair of upper tension rollers 111a and 111b. A cross-perforation cylinder 113a and a bearing cylinder 113b corresponding to the cross-perforation cylinder 113a are arranged between the pair of upper tension rollers 111a and 111b and the pair of lower tension rollers 112a and 112b. The cross-perforation cylinder 113a and the bearing cylinder 113b perforate web 1, which has been printed, in the width direction of the web 1.

A cut-off cylinder 121 is arranged below the lower tension rollers 112a and 112b. The cut-off cylinder 121 is provided with a cut-off knife for cutting off the printed web 1 in the width direction. A folding cylinder 122 faces and is in contact with the cut-off cylinder 121. The folding cylinder 122 is provided with a pin and a folding blade. The pin holds the forward edge side of a sheet having been cut off from the web 1, while the folding blade folds the sheet along the width direction at an arbitrary position thereof. A first jaw cylinder 123 faces and is in contact with the folding cylinder 122. The first jaw cylinder 123 is provided with a gripper board and a folding blade. The gripper board grips the arbitrary position of the sheet where the sheet is folded. The folding blade of the first jaw cylinder 123 is capable of folding, along the width direction at an arbitrary position thereof, a, signature 2, which is the folded sheet. A second jaw cylinder 124 faces and is in contact with the first jaw cylinder 123. The second jaw cylinder 124 is provided with a gripper board for gripping the signature 2 at an arbitrary position.

A transporting device 131 is arranged in a vicinity of the second jaw cylinder 124. The transporting device 131 transports the signature 2 with transporting belts 131b, which are wound on rollers 131a. A fan wheel 132 is arranged on the downstream side in a direction in which the transporting belts 131b of the transporting device 131 travel. A delivery conveyor 133 for delivering the signature 2 is arranged below the fan wheel 132. In FIG. 18, reference numeral 134 denotes a chopper blade.

Next, the operation of the conventional folder configured in the above-described manner will be described.

The web 1 having been longitudinally folded by a former is fed between the cross-perforation cylinder 113a and the bearing cylinder 113b via the upper tension rollers 111a and 111b. When passing through between the cross-perforation cylinder 113a and the bearing cylinder 113b, the web 1 is perforated in the width direction of the web 1 at predetermined intervals. Thereafter, the web 1 is fed between the cut-off cylinder 121 and the folding cylinder 122 via the lower tension rollers 112a and 112b. When passing through between the cut-off cylinder 121 and the folding cylinder 122, the web 1 is cut into a sheet having a predetermined length by the cut-off cylinder 121, and then is held on the folding cylinder 122.

The sheet held on the folding cylinder 122 is transported to a position where the sheet faces and is in contact with the first jaw cylinder 123. The sheet is transferred to, and then gripped by, the first jaw cylinder 123 in a manner that the sheet is folded inward by the cooperation of the folding blade of the folding cylinder 122 and the gripper board of the first jaw cylinder 123. Accordingly, the sheet is held as the signature 2 on the first jaw cylinder 123.

The signature 2 held on the first jaw cylinder 123 is transported to a position where the signature 2 faces and is in contact with the second jaw cylinder 124. When the signature 2 is to be further folded inward, the signature 2 is transferred to, and then gripped by, the second jaw cylinder 124 in a manner that the signature 2 is further folded inward, by the cooperation of the folding blade of the first jaw cylinder 123 and the gripper board of the second jaw cylinder 124. Consequently, the signature 2 is held on the second jaw cylinder 124. On the other hand, when the signature 2 is not to be further folded inward, the signature 2 is only transferred from the first jaw cylinder 123 to, and then gripped by, the second jaw cylinder 124. Consequently, the signature 2 is held on the second jaw cylinder 124. In this manner, the sheet is formed into the signature 2 of a parallel single folded signature (a double signature), a parallel double folded signature (a quarto signature) or a delta folded signature (a triple signature).

The signature 2 held on the second jaw cylinder 124 is transferred to the transporting belts 131b of the transporting device 131 so as to be transported. Then, the signature 2 is transferred onto the delivery conveyor 133 via the fan wheel 132 so as to be conveyed to the next process.

As related art documents, for example, Japanese Examined Utility Model Publication No. Hei 7-43097, Japanese Patent Application Laid-open Publication No. Hei 6-1526, and Japanese Patent Application Laid-open Publication No. 2005-335948 can be given.

In a conventional folder as described above, for example, suppose that a web 1 with a different sheet width from that of the preceding web 1 is spliced, or that the folding specification of the signature 2 is changed in the middle of the folding processing. In such a case, when the web 1 with the different sheet width is fed, or when the folding specification of the signature 2 is changed, the folder is once stopped. Then, the web 1 is cut between the upper tension rollers 111a and 111b, and the cross-perforation cylinder 113a and the bearing cylinder 113b. Thereafter, the folder is temporarily activated, so that the folding operation is continuously performed by feeding, between the cut-off cylinder 121 and the folding cylinder 122 and the like, a part of the web 1 located more downstream in the feeding direction than the position where the web 1 is cut. The sheets or the signatures 2 located more downstream in the feeding direction than the position where the web 1 is cut are thereby delivered from the inside of the folder. After that, the settings of various devices in the folder, such as the transporting device 131, are changed so that the devices can handle the sheet width or the folding specification to be changed. After that, the folder is activated again so as to restart the folding operation.

Suppose a case where the web 1 is cut between the upper tension rollers 111a and 111b, and the cross-perforation cylinder 113a and the bearing cylinder 113b as described above. The web 1 is unbalanced in the width direction since the web 1 is longitudinally folded by the former before being fed into the folder. For this reason, after a part of the web more downstream than the position where the web 1 is cut is fed between the cut-off cylinder 121 and the folding cylinder 122, the web 1 is likely to be tilted as being twisted at the edge portion, on the cut portion side, of the web 1.

When the edge portion, on the cut portion side, of the web 1 is tilted when the sheet or the signature 2 inside the folder is to be delivered, the folding operation is performed on the portion where the web 1 is twisted, as it is. As a result, a problem occurs in which a defect, such as jamming, is likely to happen near the fan wheel 132 and the like.

### SUMMARY OF THE INVENTION

Accordingly, an object of the present invention is to provide a folder in which jamming or the like can be prevented from occurring even when the sheet width or the folding specification is to be changed.

For solving the above-described problems, the present invention provides a folder including: web-transporting means which transports web; a rotatable cut-off cylinder which cuts off the web from the web-transporting means; and a rotatable holding cylinder which is arranged so as to face the outer peripheral surface of the cut-off cylinder, and which holds the forward edge side of the web to be cut off by the cut-off cylinder. The folder provides the following characteristics. The folder includes first air-blowing means and controlling means. The first air-blowing means blows air to the web located between the web-transporting means and the holding cylinder so as to force the web towards the outer peripheral surface of the holding cylinder. The controlling means controls the first air-blowing means so that air is blown out from the first air-blowing means to the web when an edge portion of the web, on the upstream side in a transporting direction in which the web is transported, is located at least between the web-transporting means and the holding cylinder.

In addition, the folder according to the present invention provides the following features. The above-described folder includes a first guide member which is arranged so as to be located between the first air-blowing means and the web, and which is capable of guiding the web.

Moreover, the folder according to the present invention provides the following features. In the above-described folder, the first guide member includes a hole for causing air from the first air-blowing means to pass through the opening portion.

Furthermore, the folder according to the present invention provides the following features. In the above-described folder, the first air-blowing means includes a first air nozzle which is arranged between the web-transporting means and the holding cylinder, and whose opening portion is directed towards the outer peripheral surface of the holding cylinder.

In addition, the folder according to the present invention provides the following features. The above-described folder further includes a second guide member and second air-blowing means. The second guide member is arranged between the web-transporting means and the holding cylinder, and which guides the web. The second air-blowing means blows air to the web located between the web-transporting means and the holding cylinder so as to force the web towards the second guide member. In the above-described folder, the controlling means controls the second air-blowing means so that air is blown out from the second air-blowing means to the web when the edge portion, on the upstream side in the transporting direction, of the web is located at least between the web-transporting means and the holding cylinder.

Moreover, the folder according to the present invention provides the following features. In the above-described folder, the second air--blowing means includes a second air nozzle which is arranged between the web-transporting means and the holding cylinder, and whose opening portion is directed towards the second guide member.

In addition, the folder according to the present invention provides the following features. The above-described folder further includes web-longitudinally-folding means which is arranged more upstream in the transporting direction than the web-transporting means, and which folds the web along the transporting direction.

Moreover, the folder according to the present invention provides the following features. The above-described folder further includes web-cutting means which is arranged more upstream in the transporting direction than the cut-off cylinder, and which cuts the web.

Furthermore, the folder according to the present invention provides the following features. In the above-described folder, the web-cutting means is arranged in the web-transporting means.

In addition, the folder according to the present invention provides the following features. In the above-described folder, an edge portion, on the upstream side in the transporting direction, of the web is an edge portion on the downstream side in the transporting direction, of the web cut by the web-cutting means.

Moreover, the folder according to the present invention provides the following features. In the above-described folder, the controlling means controls the first air-blowing means so that air starts to be blown out from the first air-blowing means before the web-cutting means cuts the web.

Furthermore, the folder according to the present invention provides the following features. The above-described folder further includes signature-transporting means and signature-detecting means. The signature-transporting means is arranged more downstream in the transporting direction of the web than the holding cylinder. The signature-detecting means detects the presence or absence of a signature transported by the signature-transporting means. In the above-described folder, the controlling means controls, on the basis of a signal from the signature-detecting means, the first air-blowing means so as to stop the blowing of air from the first air-blowing means when there is no more of the signature left.

In addition, the folder according to the present invention provides the following features. In the above-described folder, the web-transporting means includes a plurality of pairs of rollers.

Moreover, the folder according to the present invention provides the following features. In the above-described folder, the controlling means controls a cylinder group including the holding cylinder so that the cylinder group corresponds to at least one of a new folding specification and a new sheet width, after an edge portion, on the upstream side in the transporting direction, of the web is transferred from the cylinder group.

### BRIEF DESCRIPTION OF THE DRAWINGS

The present invention will become more fully understood from the detailed description given hereinbelow and the accompanying drawings which are given by way of illustration only, and thus are not limitative of the present invention and wherein;

FIG. 1 shows a schematic view of a configuration of an embodiment of a printing apparatus in which a folder according to the present invention is incorporated;

FIG. 2 shows a schematic view of an overall configuration of the folder as viewed in a direction indicated by the arrow II in FIG. 1;

FIG. 3 shows an extracted and enlarged view of a portion indicated by the arrow III in FIG. 2;

FIG. 4 shows a schematic view of a configuration in a vicinity of a folding cylinder and a first jaw cylinder in FIG. 2;

FIG. 5 shows a schematic view of a configuration of drive systems of the folding cylinder and the first jaw cylinder in FIG. 2;

FIG. 6 shows a block diagram of a drive system of the printing apparatus in FIG. 1;

FIG. 7 shows a block diagram of a control system;

FIG. 8 shows an explanatory view of an operation of an embodiment of the folder according to the present invention;

FIG. 9 shows an explanatory view of an operation subsequent to the operation of FIG. 8;

FIG. 10 shows an explanatory view of an operation subsequent to the operation of FIG. 9;

FIG. 11 shows an explanatory view of another operation subsequent to the operation of FIG. 9;

FIG. 12 shows an explanatory view of an operation subsequent to the operation of FIG. 11;

FIG. 13 shows an explanatory view of an operation subsequent to the operation of FIG. 12;

FIG. 14 shows a flowchart of the control system;

FIG. 15 shows a flowchart subsequent to the flowchart of FIG. 14;

FIG. 16 shows a flowchart subsequent to the flowchart of FIG. 15;

FIG. 17 shows a block diagram of a drive system of another embodiment of a printing apparatus in which the folder according to the present invention is incorporated; and

FIG. 18 shows a schematic view of an overall configuration of an example of a conventional folder.

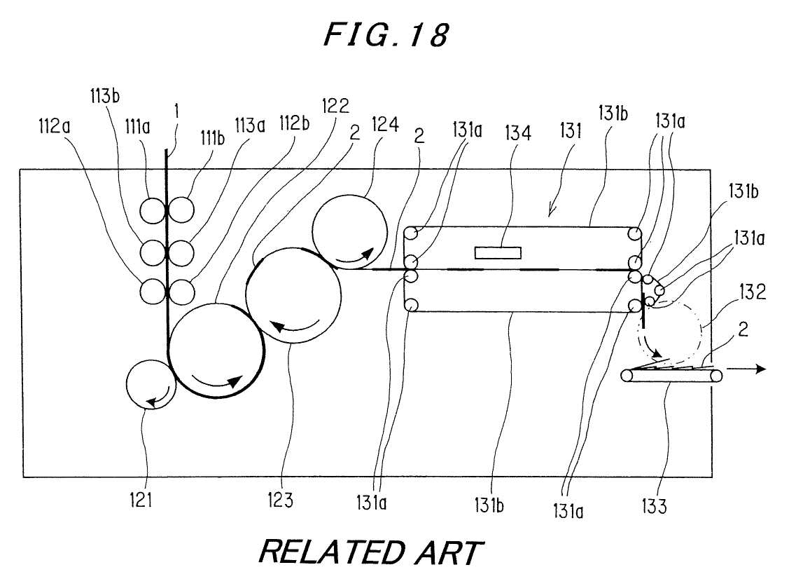

### DETAILED DESCRIPTION OF THE INVENTION

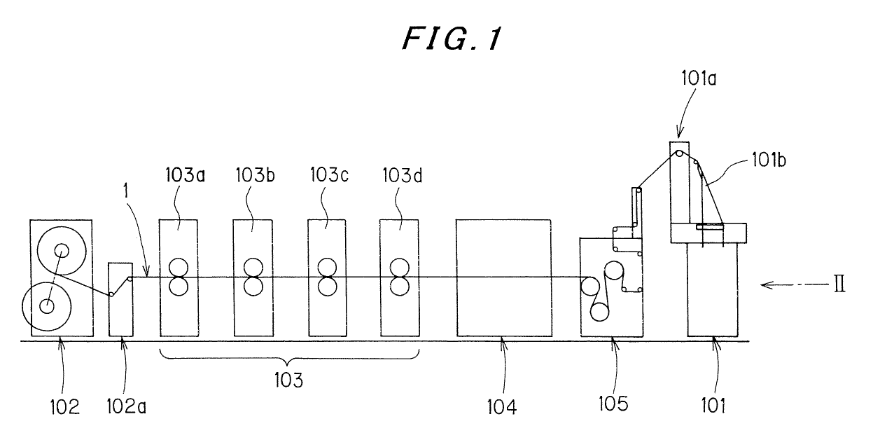

Hereinafter, descriptions will be given of embodiments of a folder according to the present invention with reference to FIGS. 1 to 7.

As shown in FIG. 1, web 1 is continuously fed from a feeder 102 and an infeeder 102a. The web 1 is then caused to pass through a first to a fourth printing units 103a to 103d in a printer 103 while various printing is performed on the web 1. Thereafter, the web 1 is heated and dried in a dryer 104, and is then cooled down in a cooler 105. Subsequently, the tension of the web 1 is adjusted and the direction in which the web 1 travels is changed, in a web path section 101a. The web 1 is then folded along the transporting direction (in the longitudinal direction) of the web 1 in a former 10lb, which serves as web-longitudinally-folding means. The longitudinally-folded web 1 is consequently fed in a folder 101. The folder 101 has a configuration as described below.

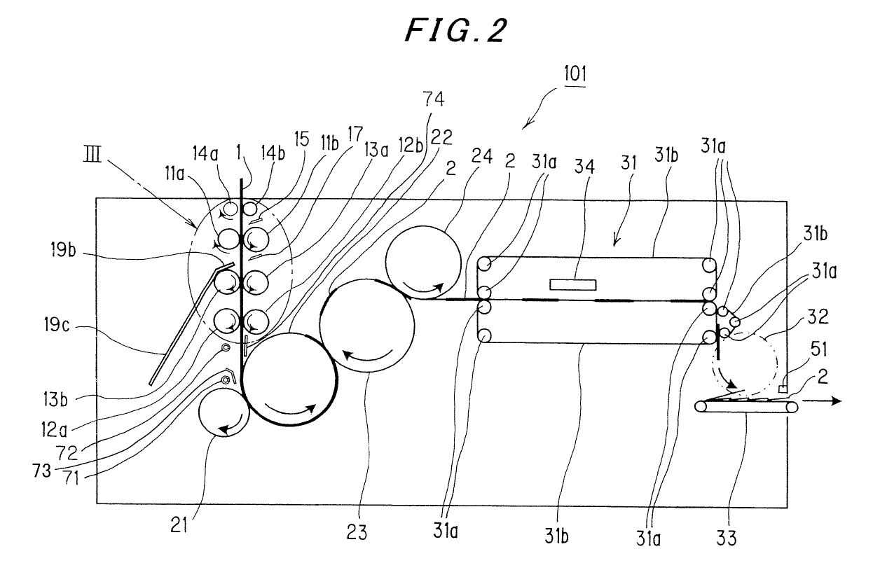

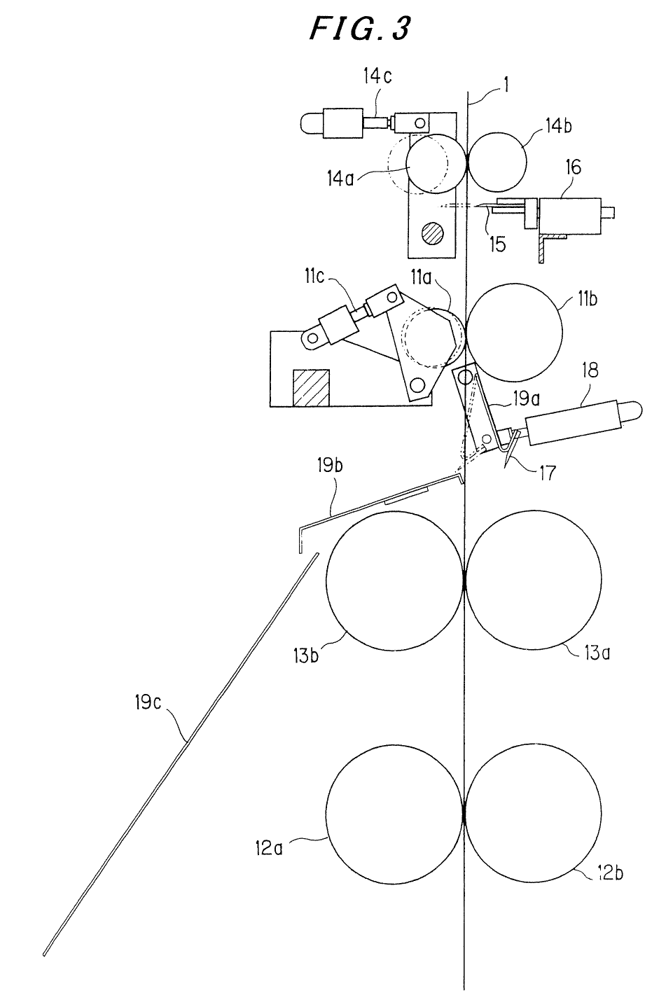

As shown in FIGS. 2 and 3, lower tension rollers 12a and 12b are arranged below upper tension rollers 11a and 11b. The upper tension rollers 11a and 11b are paired so as to hold the web 1 in between, and serve as first feeding rollers. The lower tension rollers 12a and 12b are paired so as to hold the web 1 in between, and serve as third feeding rollers. In addition, a cross-perforation cylinder 13a and a bearing cylinder 13b corresponding to the cross-perforation cylinder 13a are arranged between the pair of upper tension rollers 11a and 11b and the pair of lower tension rollers 12a and 12b. The cross-perforation cylinder 13a and the bearing cylinder 13b perforate the web 1 having been printed in the width direction of the web 1. Moreover, auxiliary rollers 14a and 14b are arranged above the upper tension rollers 11a and 11b. The auxiliary rollers 14a and 14b are paired so as to hold the web 1 in between, and serve as second feeding rollers.

The upper tension rollers 11a and 11b are brought into contact with each other, and are also separated from each other, by an actuator 11c, which serves as first-feeding-roller-moving means. Specifically, the roller 11a is brought into contact with, and is also separated from, the opposite roller 11b, according to the operation of the actuator 11c. The auxiliary rollers 14a and 14b are brought into contact with each other, and are also separated from each other, by an actuator 14c, which serves as second-feeding-roller-moving means. Specifically, the roller 14a is brought into contact with, and is also separated from, the opposite roller 14b, according to the operation of the actuator 14c.

A cutting knife 15 is arranged between the pair of auxiliary rollers 14a and 14b and the pair of upper tension rollers 11a and 11b. The cutting knife 15 cuts the web 1 along the width direction of the web 1 according to the operation of an actuator 16. A guide plate 19a is arranged between the pair of upper tension rollers 11a and 11b and the set of the cross-perforation cylinder 13a and the bearing cylinder 13b. The guide plate 19a is supported so as to be swung about the upper end portion of the guide plate 19a, while a cutting knife 17 is arranged on the side of the lower end portion of the guide plate 19a.

An end portion of an actuator 18 is connected to the lower end portion of the guide plate 19a with a pin. The web 1 can be cut along the width direction of the web 1 with the cutting knife 17 by extending a rod of the actuator 18. Moreover, by positioning the lower end portion of the guide plate 19a on the path line of the web 1, it is possible to change the direction in which the upper piece of the cut web 1 is fed from a direction towards the web-feeding side (towards the right bottom in FIGS. 2 and 3) to a direction towards guide plates 19b and 19c on the web-discharging side (to the left side in FIGS. 2 and 3).

In the present embodiment, the cutting knife 15, the actuator 16 and the like constitute second-web-cutting means, while the cutting knife 17, the actuator 18 and the like constitute first-web-cutting means. The first-web-cutting-off means, the second-web-cutting means and the like constitute web-cutting-off means. In addition, the actuator 18, the guide plates 19a to 19c, and the like constitute transporting-direction-switching means. Moreover, the upper tension rollers 11a and 11b, serving respectively as the first feeding rollers, the actuator 11c, serving as first-feeding-roller-moving means, and the like constitute web-feeding means. Furthermore, the upper tension rollers 11a and 11b, the lower tension rollers 12a and 12b, the auxiliary rollers 14a and 14b, and the like constitute web-transporting means.

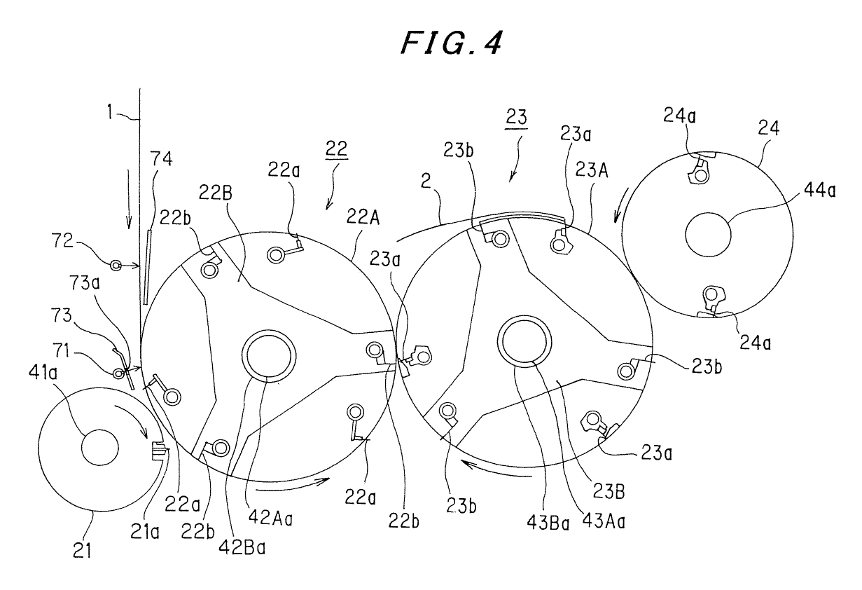

As shown in FIGS. 2 and 4, a cut-off cylinder 21 is arranged below the lower tension rollers 12a and 12b. The cut-off cylinder 21 is provided with a cut-off knife 21a for cutting the printed web 1 along the width direction of the web 1. A folding cylinder 22, which is a double-cylinder type holding cylinder, faces and is in contact with the cut-off cylinder 21. The folding cylinder 22 includes a first cylinder 22A for the folding cylinder and a second cylinder 22B for the folding cylinder. The first and second cylinder 22A and 22B are mounted on the same shaft in a manner that the second cylinder 22B rotates in the circumferential direction thereof. The first cylinder 22A is provided with a plurality of pins 22a arranged at predetermined intervals in the circumferential direction of the first cylinder 22A. Each pin 22a holds the forward edge side of a sheet of the web 1, which has been cut. The second cylinder 22B is provided with a plurality of folding blades 22b arranged at predetermined intervals in the circumferential direction of the second cylinder 22B. Each folding blade 22b folds the sheet along the width direction at an arbitrary position.

A double-cylinder type first jaw cylinder 23 faces and is in contact with the folding cylinder 22. The first jaw cylinder 23 includes a first cylinder 23A for the first jaw cylinder and a second cylinder 23B for the first jaw cylinder. The first and second cylinders 23A and 23B are mounted on the same shaft so that the second cylinder 23B rotates in the circumferential direction thereof. The first cylinder 23A is provided with a plurality of gripper boards 23a arranged at predetermined intervals in the circumferential direction of the first cylinder 23A. Each gripper board 23a grips the arbitrary position of the sheet where the sheet is folded. The second cylinder 23B is provided with a plurality of folding blades 23b arranged at predetermined intervals in the circumferential direction of the second cylinder 23B. Each folding blade 23b folds a signature 2, which is the folded sheet, along the width direction of the signature 2. A second jaw cylinder 24 faces and is in contact with the first jaw cylinder 23. The second jaw cylinder 24 is provided with gripper boards 24a for gripping the signature 2 at an arbitrary position.

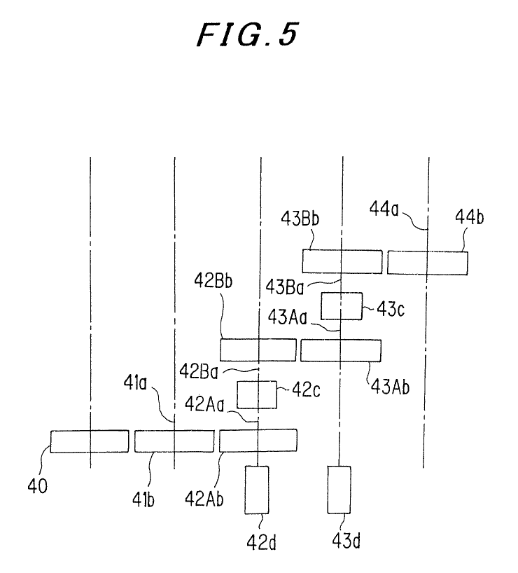

As shown in FIG. 5, a cut-off cylinder gear 41b engaged with a drive gear 40 is mounted on a cut-off cylinder drive shaft 41a for rotationally driving the cut-off cylinder 21. A first cylinder gear 42Ab engaged with the cut-off cylinder gear 41b is mounted on a first cylinder drive shaft 42Aa for rotationally driving the first cylinder 22A of the folding cylinder 22. A second cylinder drive shaft 42Ba is connected to the first cylinder drive shaft 42Aa with a folding-cylinder differential gear 42c (constituted of a harmonic drive (trademark)) for performing phase adjustment interposed in between. The second cylinder drive shaft 42Ba rotationally drives the second cylinder 22B of the folding cylinder 22. A second cylinder gear 42Bb is mounted on the second cylinder drive shaft 42Ba.

A first cylinder gear 43Ab engaged with the second cylinder gear 42Bb is mounted on a first cylinder drive shaft 43Aa for rotationally driving the first cylinder 23A of the first jaw cylinder 23. A second cylinder drive shaft 43Ba is connected to the first cylinder drive shaft 43Aa with a, first-jaw-cylinder differential gear 43c (constituted of a harmonic drive (trademark)) for performing phase adjustment interposed in between. The second cylinder drive shaft 43Ba rotationally drives the second cylinder 23B of the first jaw cylinder 23. A second cylinder gear 43Bb is mounted on the second cylinder drive shaft 43Ba. A second jaw cylinder gear 44b engaged with the second cylinder gear 43Bb is mounted on a second jaw cylinder drive shaft 44a for rotationally driving the second jaw cylinder 24.

In addition, a folding-cylinder phase-adjusting motor 42d is connected to the folding-cylinder differential gear 42c. The folding-cylinder phase-adjusting motor 42d rotates the second cylinder drive shaft 42Ba so as to change the phase of the second cylinder 22B with respect to the first cylinder 22A of the folding cylinder 22. Moreover, a first-jaw-cylinder phase-adjusting motor 43d is connected to the first-jaw-cylinder differential gear 43c. The first-jaw-cylinder phase-adjusting motor 43d rotates the second cylinder drive shaft 43Ba so as to change the phase of the second cylinder 23B with respect to the first cylinder 23A of the first jaw cylinder 23.

Incidentally, each of the differential gears 42c and 43c is a known differential gear having the following configuration. Specifically, the differential gear is essentially configured of a Wave generator; a Flexspline fitted on the periphery of the Wave generator; a Circular Spline engaged with the periphery of the Flexspline; output and input gears screwed respectively into the two sides of the Circular Spline. In addition, in the differential gear, the number of teeth of the Circular Spline is larger than the number of teeth of the Flexspline.

Accordingly, when the folding-cylinder phase-adjusting motor 42d is stopped, the folding-cylinder differential gear 42c transmits the power from the drive gear 40 with no phase adjustment to the second cylinder gear 42Bb of the folding cylinder 22, and then to the first cylinder gear 43Ab of the first jaw cylinder 23, via the cut-off cylinder gear 41b and the first cylinder gear 42Ab of the folding cylinder 22. On the other hand, when the first-jaw-cylinder phase-adjusting motor 43d is stopped, the first-jaw-cylinder differential gear 43c transmits the power from the first cylinder gear 43Ab with no phase adjustment to the second cylinder gear 43Bb of the first jaw cylinder 23 and the second jaw cylinder gear 44.

When the folding-cylinder phase-adjusting motor 42d is operated, the operation of the folding-cylinder differential gear 42c changes the phase of the second cylinder gear 42Bb of the folding cylinder 22 with respect to the first cylinder gear 42Ab thereof. At the same time, the first and second cylinder gears 43Ab and 43Bb of the first jaw cylinder 23 and the second jaw cylinder gear 44b also rotate so as to match the phase of the second cylinder gear 42Bb of the folding cylinder 22, in synchronization with the rotation of the second cylinder gear 42Bb of the folding cylinder 22 associated with the phase change. Moreover, when the first-jaw-cylinder phase-adjusting motor 43d is operated, the operation of the first-jaw-cylinder differential gear 43c changes the phase of the second cylinder gear 43Bb of the first jaw cylinder 23 with respect to the first cylinder gear 43Ab thereof. At the same time, the second jaw cylinder gear 44b also rotates so as to match the phase of the second cylinder gear 43Bb of the first jaw cylinder 23, in synchronization with the rotation of the second cylinder gear 43Bb of the first jaw cylinder 23 associated with the phase change.

In this manner, the operating of the phase-adjusting motors 42d and 43d changes the phases of the respective gears 42Bb, 43Ab, 43Bb, and 44b, so that the phase relationship is changed among the first and second cylinders 22A and 22B of the folding cylinder 22, the first and second cylinders 23A and 23B of the first jaw cylinder 23, and the second jaw cylinder 24. Accordingly, the phase relationship is switched among the pins 22a and the folding blades 22b of the folding cylinder 22, the gripper boards 23a and the folding blades 23b of the first jaw cylinder 23, and the gripper boards 24a of the second jaw cylinder 24, so that the folding specification and the like of the signature 2 is changed.

In the present embodiment described above, the drive shafts 42Aa and 42Ba, the gears 42Ab and 42Bb, the differential gear 42c, the motor 42d and the like constitute folding-cylinder-phase-adjusting means, while the drive shafts 43Aa and 43Ba, the gears 43Ab and 43Bb, the differential gear 43c, the motor 43d and the like constitute first-jaw-cylinder-phase-adjusting means.

As shown in FIGS. 2 and 4, a first air nozzle 71 is arranged between the lower tension rollers 12a and 12b, and the cut-off cylinder 21 and the folding cylinder 22, in a manner that the web 1 is located between the first air nozzle 71 and the outer peripheral surface of the folding cylinder 22. The first air nozzle 71 is connected to an air pump (not illustrated) and the opening portion of the first air nozzle 71 is directed towards the outer peripheral surface of the folding cylinder 22. In addition, a guide plate 74 serving as a second guide member for guiding the web 1 is arranged between the lower tension rollers 12a and 12b, and the first air nozzle 71, that is, between the lower tension rollers 12a and 12b, and the cut-off cylinder 21 and the folding cylinder 22. A second air nozzle 72 is also arranged between the lower tension rollers 12a and 12b, and the cut-off cylinder 21 and the folding cylinder 22, in a manner that the web 1 is placed between the second air nozzle 72 and the guide plate 74. The second air nozzle 72 is connected to the air pump (not illustrated) , and the opening portion of the second air nozzle 72 is directed towards the guide plate 74.

A guide plate 73 serving as a first guide member for guiding the web 1 is arranged between the first air nozzle 71 and the web 1. A hole 73a for causing air from the first air nozzle 71 to pass through the hole 73a is formed in the guide plate 73.

As shown in FIG. 2, a transporting device 31 is arranged in a vicinity of the second jaw cylinder 24. The transporting device 31 transports the signature 2 with transporting belts 31b which is wound on rollers 31a. A fan wheel 32 is arranged on the downstream side in a direction in which the transporting belts 31b of the transporting device 31 travel. A delivery conveyor 33 is arranged below the fan wheel 32, and delivers the signature 2. A signature sensor 51 is arranged in a vicinity of the delivery conveyor 33. The signature sensor 51 serves as signature-detection means that detects the presence or absence of the signature 2.

In the present embodiment, the cut-off cylinder 21 and the like constitute cutting-off means. The folding cylinder 22, the first jaw cylinder 23, the second jaw cylinder 24 and the like constitute a cylinder group as well as folding means. The transporting device 31, the fan wheel 32, the delivery conveyor 33 and the like constitute signature-transporting means. In FIG. 2, reference numeral 34 denotes a chopper blade.

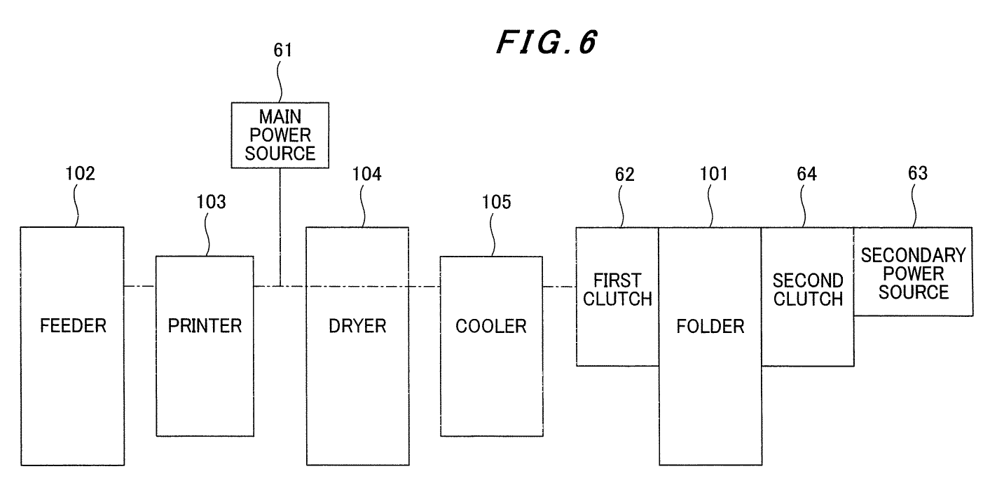

In addition, as shown in FIG. 6, the drive gear 40, the transporting device 31, the fan wheel 32 and the delivery conveyor 33 are connected, via a first clutch 62, to a power transmission system of a main power source 61 for supplying power to the feeder 102, the printer 103, the dryer 104, the cooler 105 and the like, of the printing apparatus. The drive gear 40, the transporting device 31, the fan wheel 32, and the delivery conveyor 33 are also connected, via a second clutch 64, to a secondary power source 63 for supplying power to only the drive gear 40, the transporting device 31, the fan wheel 32 and the delivery conveyor 33.

On the other hand, the rollers 11a, 12a, and 14a, the cross-perforation cylinder 13a, and the bearing cylinder 13b are connected to the power transmission system of the main power source 61 in the same manner as that of the feeder 102, the printer 103, the dryer 104, the cooler 105 and the like, of the printing apparatus. That is, the rollers 11a, 12a, and 14a, the cross-perforation cylinder 13a and the bearing cylinder 13b are connected directly to the power transmission system without the first clutch 62 in between.

In other words, the rollers 11a, 12a, and 14a, the cross-perforation cylinder 13a, and the bearing cylinder 13b are interlocked with the operation of the main power source 61, together with the feeder 102, the printer 103, the dryer 104, the cooler 105 and the like, of the printing apparatus. The engagement of the first clutch 62 causes the drive gear 40, the transporting device 31, the fan wheel 32, and the delivery conveyor 33 to be interlocked with the operation of the main power source 61, together with the feeder 102, the printer 103, the dryer 104, the cooler 105 and the like, of the printing apparatus, as well as the rollers 11a, 12a, and 14a, the cross-perforation cylinder 13a, and the bearing cylinder 13b. When the operation of the main power source 61 is stopped and the first clutch 62 is disengaged, the drive gear 40, the transporting device 31, the fan wheel 32, and the delivery conveyor 33 can be independently operated by operating the secondary power source 63 and by engaging the second clutch 64, in a state where not only the operations of the feeder 102, the printer 103, the dryer 104, the cooler 105 and the like, of the printing apparatus, but also the operations of the rollers 11a, 12a, and 14a, the cross-perforation cylinder 13a, and the bearing cylinder 13b, are stopped.

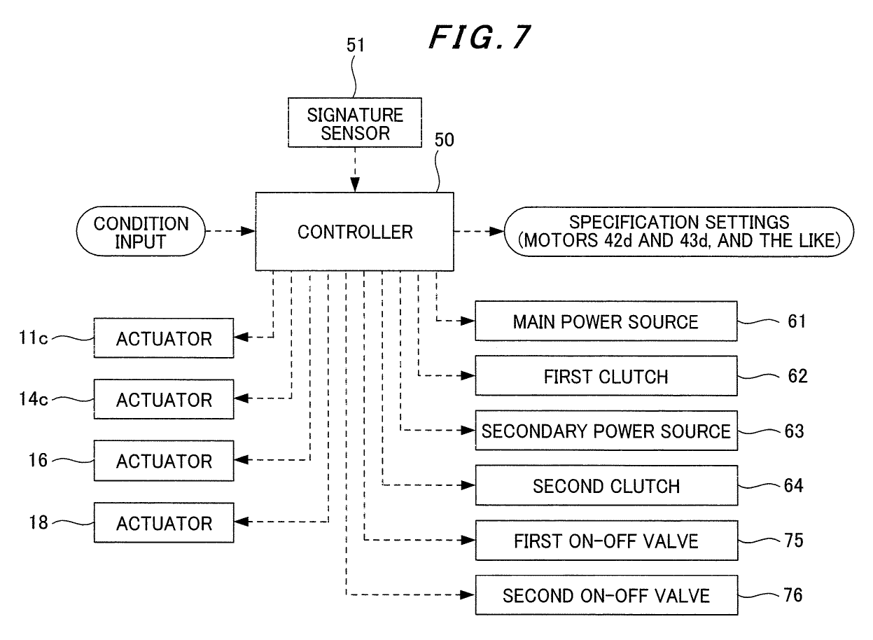

As shown in FIG. 7, an output unit of a controller 50 is electrically connected to the power sources 61 and 63, operating sources of the clutches 62 and 64, and the actuators 11c, 14c, 16, and 18. The controller 50 is controlling means. When conditions including the sheet width of the web 1 and the folding specification of the signature 2 are selectively inputted to the controller 50, the controller 50 operates the phase-adjusting motors 42d and 43d, and the like. In this manner, the controller 50 changes the settings of various devices in the folder 101, such as the cylinders 21 to 24 and the transporting device 31, in accordance with the width of sheet of paper, the folding specification and the like, thus selected.

In addition, first and second electromagnetic on-off valves 75 and 76 are electrically connected to the output unit of the controller 50. The first and second electromagnetic on-off valves 75 and 76 are provided between the first air nozzle 71 and the air pump, and between the second air nozzle 72 and the air pump, respectively. On the other hand, the signature sensor 51 is electrically connected to an input unit of the controller 50. When the conditions including the sheet width and the folding specification are selectively inputted to the controller 50, the controller 50 operates, on the basis of signals from the signature sensor 51, the phase-adjusting motors 42d and 43d, and the like. In this manner, the controller 50 changes the settings of various devices in the folder 101, such as the cylinders 21 to 24 and the transporting device 31, and concurrently controls the operations respectively of the power sources 61 and 63, the clutches 62 and 64, the actuators 11c, 14c, 16, and 18, and the on-off valves 75 and 76.

In the present embodiment, the first air nozzle 71, the first on-off valve 75, the air pump and the like constitute first air-blowing means. On the other hand, the second air nozzle 72, the second on-off valve 76, the air pump and the like constitute second air-blowing means.

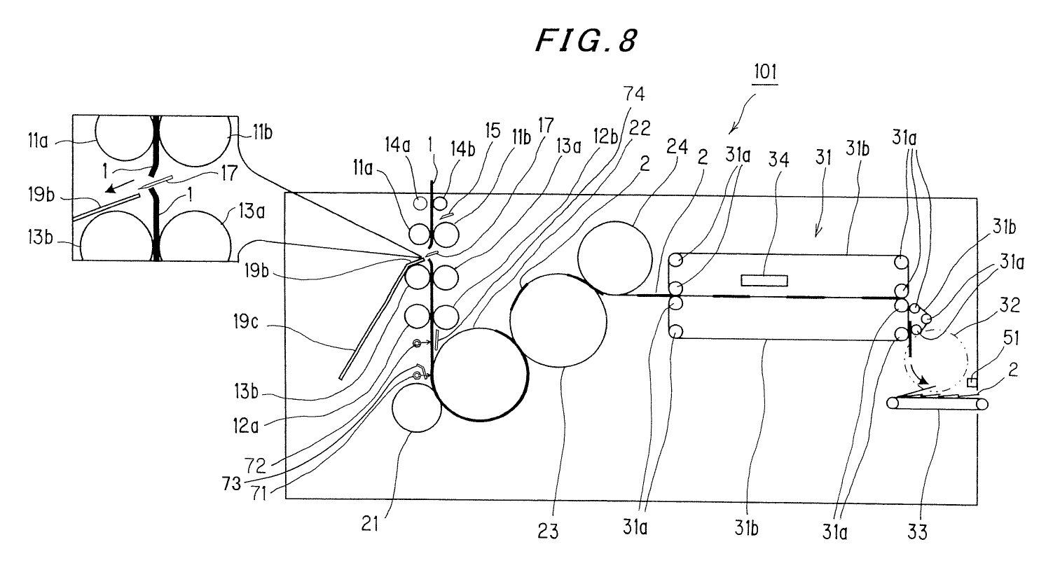

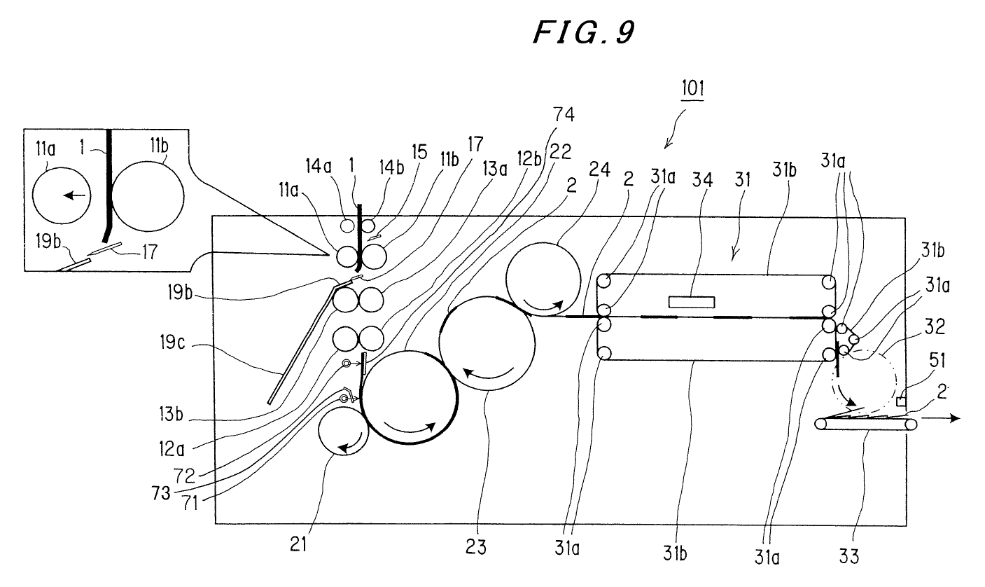

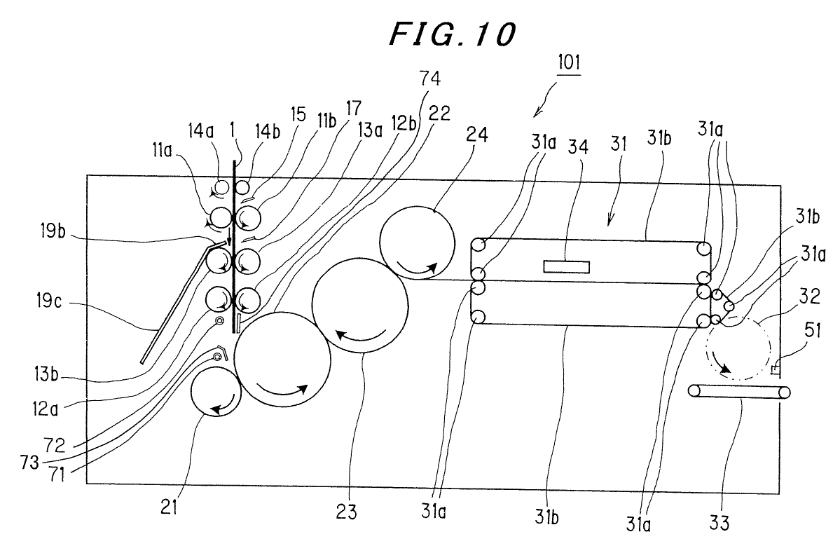

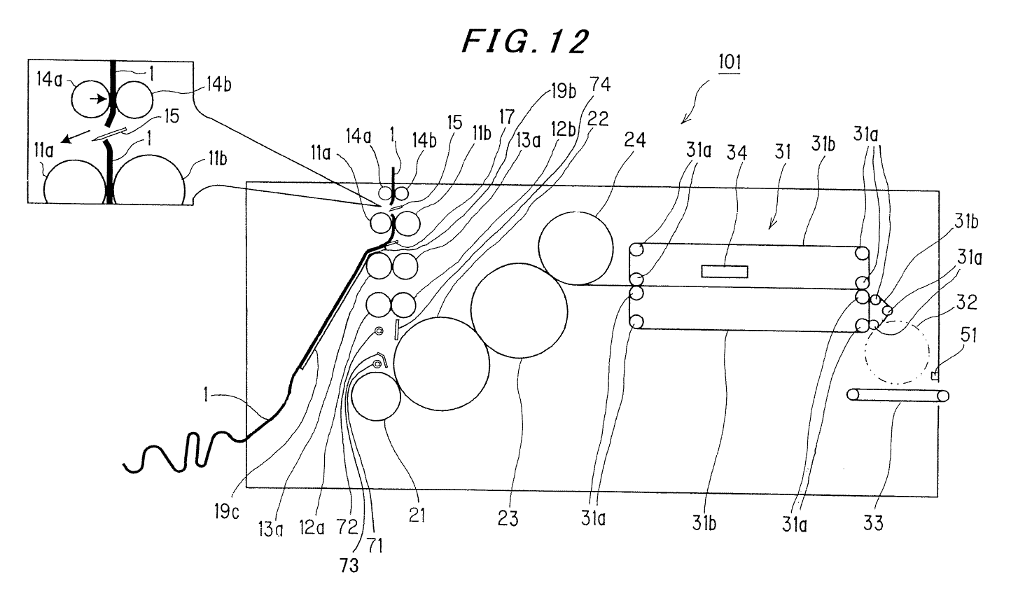

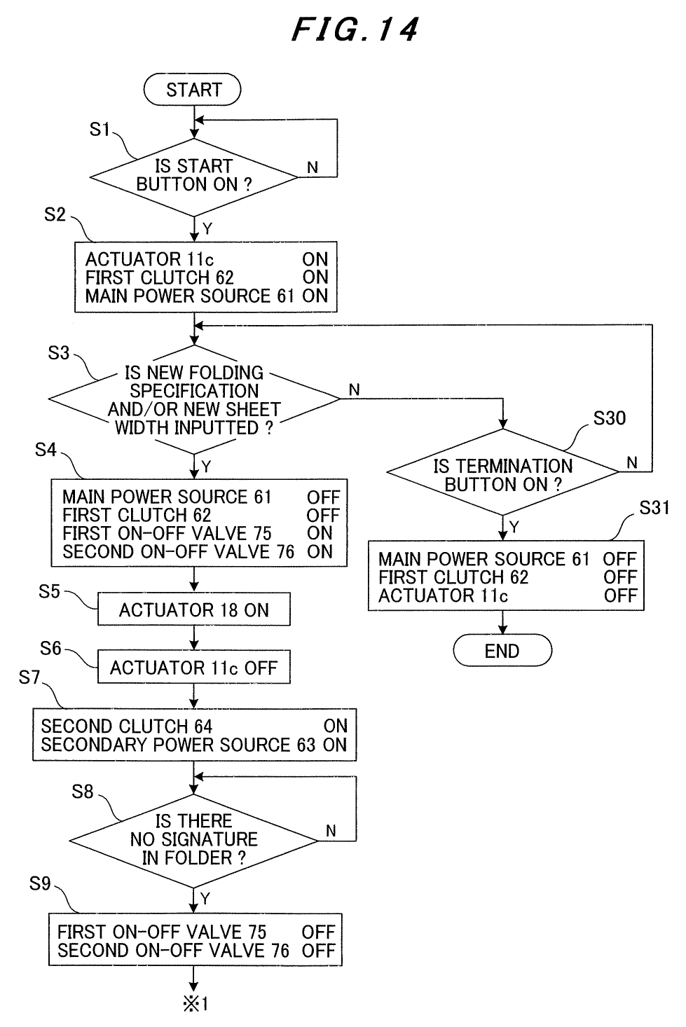

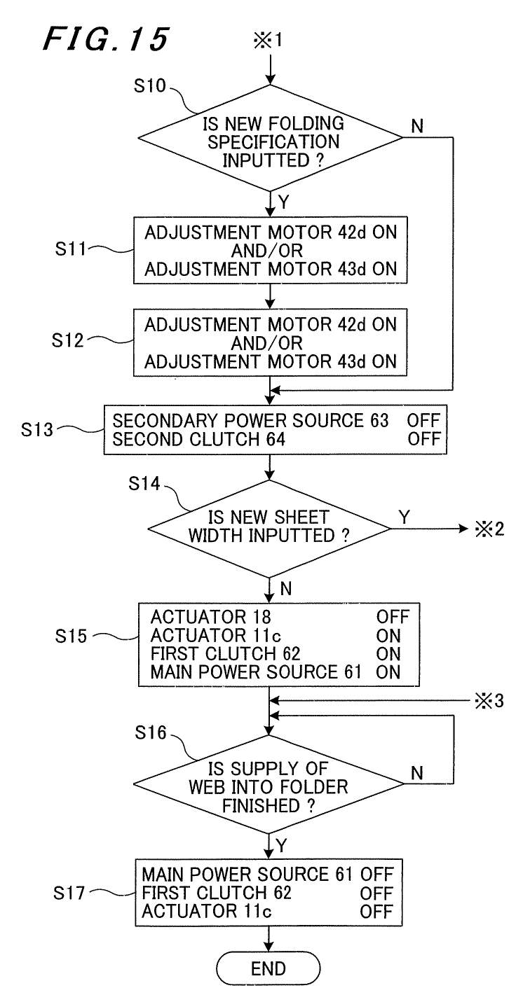

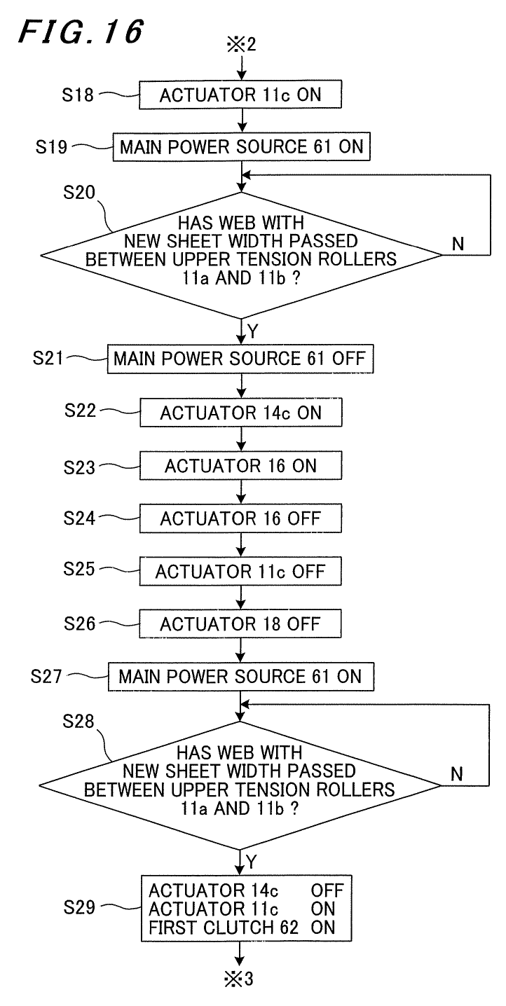

Descriptions will be given below of the operation of the folder according to the present embodiment, in which folder is configured as described above, with reference to FIGS. 8 to 16. As shown in FIGS. 14 to 16, when a start button is turned ON (S1) , the controller 50 causes the actuator 11c to extend (ON) so that the upper tension roller 11a is brought into contact with the opposite roller 11b. At the same time, the controller 50 causes the first clutch 62 to be engaged (ON), and activates the main power source 61 (ON) (S2) At this time, the second clutch 64 is not engaged (OFF) and the secondary power source 63 is not operated.

Then, the web 1 having been longitudinally folded by the former 101b is fed between the cross-perforation cylinder 13a and the bearing cylinder 13b via the upper tension rollers 11a and 11b so as to be perforated in the width direction at predetermined intervals. Subsequently, the web 1 is fed between the cut-off cylinder 21 and the folding cylinder 22 via the lower tension rollers 12a and 12b so as to be cut into a sheet having a predetermined length. Then the sheet is held on the folding cylinder 22.

The sheet held on the folding cylinder 22 is transported to a position where the sheet faces and is in contact with the first jaw cylinder 23. At the position, the sheet is transferred to, and then gripped by, the first jaw cylinder 23 in a manner that the sheet is folded inward by the cooperation of the folding blade 22b of the folding cylinder 22 and the gripper board 23a of the first jaw cylinder 23. Consequently, the sheet is held as the signature 2 on the first jaw cylinder 23.

The signature 2 held on the first jaw cylinder 23 is transported to a position where the signature 2 faces and is in contact with the second jaw cylinder 24. When the signature 2 is to be further folded inward, the signature 2 is transferred to, and then gripped by, the second jaw cylinder 24 in a manner that the signature 2 is further folded inward, by the cooperation of the folding blade 23b of the first jaw cylinder 23 and the gripper board 24a of the second jaw cylinder 24. Consequently, the signature 2 is held on the second jaw cylinder 24. On the other hand, when the signature is not to be further folded inward, the signature 2 is only transferred from the first jaw cylinder 23 to, and then gripped by, the second jaw cylinder 24 so as to be held thereon.

The signature 2 held on the second jaw cylinder 24 is transferred to the transporting belts 31b of the transporting device 31 so as to be transported. The signature 2 is transferred onto the delivery conveyor 33 via the fan wheel 32, and is then conveyed to the next process. When there is no need for changing the folding specification and the sheet width, and also when a preset number of signatures 2 are delivered to the transporting device 31, the operation can be stopped in the following manner. Specifically, when a terminating button is turned ON (S30) , the controller 50 stops the operation of the mainpower source 61 (OFF), and causes the first clutch 62 to be disengaged (OFF) At the same time, the controller 50 causes the actuator 11c to contract (OFF) so that the upper tension roller 11a is separated from the opposite roller 11b (S31).

Suppose that, for example, at least one of the folding specification and the sheet width is selected to be changed to a new folding specification or a sheet width in the middle of the operation when the web 1 is formed into signatures 2 in the above-described manner. In this case, at least one of the folding specification and the sheet width is inputted to the controller 50 (S3). Accordingly, the controller 50 activates the main power source 61 so that the printing phase of the web 1 is placed at a predetermined position, and then stops the main power source 61 (OFF) . The controller 50 then causes the first clutch 62 to be disengaged (OFF) while causing the on-off valves 75 and 76 to be opened (ON) so that air from the air pump is blown out through the air nozzles 71 and 72 (S4).

Next, the controller 50 causes the actuator 18 to extend (ON) (S5) so that the cutting knife 17 cuts the web 1 (refer to FIG. 8). At the same time, the controller 50 causes the guide plate 19a to prevent the cut web 1 on the upstream side in the feeding direction from entering into between the cross-perforation cylinder 13a and the bearing cylinder 13b.

Subsequently, the controller 50 causes the actuator 11c to contract (OFF) (S6) so that the upper tension roller 11a is separated from the opposite roller 11b. Accordingly, the cut web 1 on the upstream side in the feeding direction is not fed. Thereafter, the controller 50 causes the second clutch 64 to be engaged (ON), and also activates the secondary power source 63 (ON) (S7). Accordingly, only the cylinders 21 to 24, the transporting device 31, the fan wheel 32, and the delivery conveyor 33 are operated. As a result, the sheet or the signature 2, located among the lower tension rollers 12a and 12b, the cylinders 13a, 13b, and 21 to 24, the transporting device 31, the fan wheel 32, and the delivery conveyor 33 is delivered to the outside. That is, only the sheet or the signature 2, having been cut, on the downstream side in the feeding direction is delivered to the outside.

At this time, air blown out from the air nozzles 71 and 72 causes the web 1, located between the lower tension rollers 12a and 12b, and located between the cut-off cylinder 21 and the folding cylinder 22 to be securely supported on the guide plate 74 and the outer peripheral surface of the folding cylinder 22. Accordingly, the edge portion, on the upstream side in the feeding direction, of the cut web 1 on the downstream side in the feeding direction is prevented from being tilted.

Subsequently, when the controller 50 detects, on the basis of a signal from the signature sensor 51, that all the signatures 2 or the like left inside the folder 101 are transferred (S8) , the controller 50 closes the on-off valves 75 and 76 so as to stop the blowing of air from the air nozzles 71 and 72 (S9). When a new folding specification is selectively inputted (S10), the controller 50 activates the phase-adjusting motors 42d and 43d, and the like. Accordingly, the settings of various devices in the folder 101, such as the cylinders 21 to 24, the transporting device 31, and the like, are changed in response to the condition on the folding specification (S11 and S12). On the other hand, when a new folding specification is not selectively inputted, the controller 50 does not activate the phase-adjusting motors 42d and 43d so that this process is omitted.

Next, the controller 50 stops the operation of the secondary power source 63 (OFF), and then causes the second clutch 64 to he disengaged (OFF) (S13). When a new sheet width of the web 1 is not selectively inputted (S14) , the controller 50 causes the actuator 18 to contract (OFF) so that the cutting knife 17 and the guide plate 19a are returned respectively to the original positions. At the same time, the controller 50 causes the actuator 11c to extend (ON) so that the upper tension roller 11a is brought into contact with the opposite roller 11b. Thereafter, the controller 50 causes the first clutch 62 to be engaged (ON) , and then activates the main power source 61 (ON) (S15). Accordingly, the cut web 1 on the upstream side in the feeding direction is started to be fed to the web-feeding side.

When the controller 50 detects, on the basis of a signal from the signature sensor 51, that the signature 2 is transferred to the delivery conveyor 33, in other words, when the controller 50 detects that the web 1 is fed into the folder 101 (Sl6), the settings for the new folding specification are completed in the following manner. The controller 50 first stops the operation of the main power source 61 (OFF) , then causes the first clutch 62 to be disengaged (OFF), and also causes the actuator 11c to contract (OFF) so that the upper tension roller 11a is separated from the opposite roller 11b (S17).

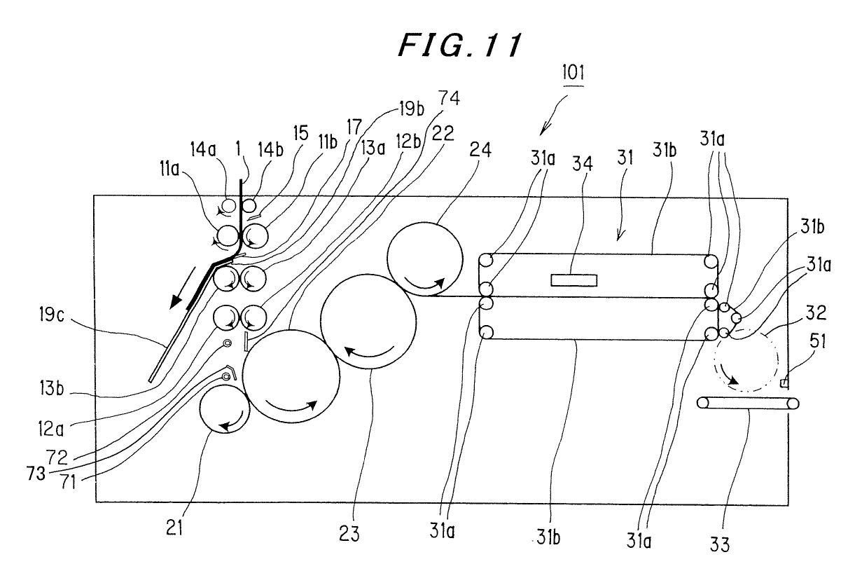

On the other hand, suppose that, for example, the web 1 having a sheet width different from that of the preceding web 1 is to be spliced with the preceding web 1, or that a new sheet width has been selectively inputted, when the fed web 1 is to be formed into signatures 2 (S14). The controller 50 causes the actuator 11c to extend (ON) (S18) so that the upper tension roller 11a is brought into contact with the opposite roller 11b. Accordingly, the cut web 1 on the upstream side in the feeding direction is enabled to be fed. At the same time, the controller 50 activates the main power source 61 (ON) (S19) so that the upper tension rollers 11a and 11b are driven to rotate. Accordingly, the cut web 1 on the upstream side in the feeding direction is transferred along the guide plates 19a to l9c (refer to FIG. 11) so as to be guided to the web-discharging side. At this time, the first and second clutches 62 and 64 are not engaged, while the secondary power source 63 is not operated.

When the controller 50 detects, on the basis of the amount of the fed web 1, that the forward edge of the web 1 having been newly spliced reaches on the guide plates 19a to 19c, with web-feeding-amount-detecting means, such as a rotary encoder, provided to the printer 103, in other words , when the web 1 with the new sheet width reaches a position facing the cutting knife 15 (S20), the controller 50 temporarily stops the operation of the main power source 61 (OFF) (S21) . Then, the controller 50 causes the actuator 14c to extend (ON) (S22) so that the auxiliary roller 14a is brought into contact with the opposite roller 14b, and thereby causes the auxiliary rollers 14a and 14b to hold the web 1. Thereafter, the controller 50 causes the actuator 16 to extend (ON) (S23) so that the cutting knife 15 cuts the web 1 at a position between the auxiliary rollers 14a and 14b, and the upper tension rollers 11a and 11b (refer to FIG. 1.2).

Next, the controller 50 causes the actuator 16 to contract (OFF) (S24) so that the cutting knife 15 is returned to the original position. At the same time, the controller 50 causes the actuator 11c to contract (OFF) (S25) so that the upper tension roller 11a is separated from the opposite roller 11b. Accordingly, the forward edge of the web 1 having been newly spliced is discharged to the web-discharging side.

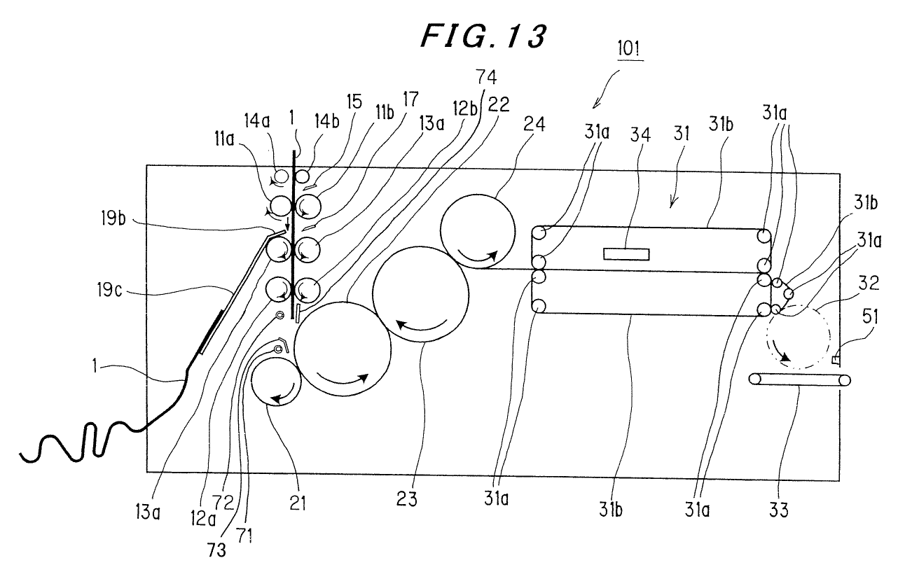

Subsequently, the controller 50 causes the actuator 18 to contract (OFF) (S26) so that the cutting knife 17 and the guide plate 19a are returned respectively to the original positions. In addition, the controller 50 activates the main power source 61 (ON) (S27) so that the auxiliary rollers 14a and 14b are driven to rotate. Accordingly, the web 1 cut by the cutting knife 15 on the upstream side in the feeding direction is started to be fed to the feeding side. When the controller 50 detects, on the basis of the amount of the fed web 1, that the forward edge of the web 1 passes through between the upper tension rollers 11a and 11b, with the web-feeding-amount-detecting means provided to the printer 103, such as the rotary encoder (S28), the controller 50 causes the actuator 14c to contract (OFF) so that the auxiliary roller 14a is separated from the opposite roller 14b. At the same time, the controller 50 causes the actuator 11c to extend (ON) so that the upper tension roller 11a is brought into contact with the opposite roller 11b. Accordingly, the rollers for the feeding of the web 1 are switched from the auxiliary rollers 14a and 14b to the upper tension rollers 11a and 11b. At the same time, the controller 50 causes the first clutch 62 to be engaged (ON) so that the cylinders 21 to 24, the transporting device 31, the fan wheel 32 and the delivery conveyor 33 are activated (S29) (refer to FIG. 13).

When the controller 50 detects, on the basis of a signal from the signature sensor 51, that the signature 2 is transferred onto the delivery conveyor 33, in other words, when the controller 50 detects that the web 1 is fed into the folder 101 (S16), the controller 50 stops the operation of the main power source 61 (OFF), causes the first clutch to be disengaged (OFF) , and also causes the actuator 11c to contract (OFF) so that the upper tension roller 11a is separated from the opposite roller 11b (S17). Consequently, the settings for the new sheet width are completed.

That is, in the folder 101 according to the present embodiment, air is blown out from the air nozzles 71 and 72 from the time when the web 1 is cut by the cutting knife 17 to the time when a11 the sheet and the signatures 2 in the folder 101 are delivered to the outside. In this manner, the web 1 located between the lower tension rollers 12a and 12b, and the cut-off cylinder 21 and the folding cylinder 22 is securely supported on the guide plate 74 and the outer peripheral surface of the folding cylinder 22.

Accordingly, even in the case where the web 1 is unbalanced in the width direction as being longitudinally folded by the former 101b, it is possible to prevent, from being tilted, the edge portion, on the cut side, of the web 1 cut by the cutting knife 17 on the downstream side in the feeding direction.

For this reason, according to the present embodiment, even when the sheet width or the folding specification is to be changed, it is possible to prevent the jamming and the like in the fan wheel 32 and the like.

In the present embodiment, the controller 50 controls the on-off valves 75 and 76 so that air is blown out from the air nozzles 71 and 72 from the time when the web 1 is cut by the cutting knife 17 (S5) to the time when all the sheet and the signature 2 in the folder is delivered to the outside (S8). The present invention is not limited to this. The same operational effect as that of the present embodiment may be obtained also in the following manner. Specifically, the controller 50 controls the on-off valves 75 and 76 so that air is blown out from the air nozzles 71 and 72, while the edge portion, on the upstream side in the transporting direction, of the web 1 that is cut by the cutting knife 17 on the downstream side in the transporting direction is located at least between the lower tension rollers 12a and 12b, and the folding cylinder 22.

In addition, in the present embodiment, the first air nozzle 71 is arranged in the position near the folding cylinder 22, between the lower tension rollers 12a and 12b, and the cut-off cylinder 21 and the folding cylinder 22. On the other hand, the guide plate 74 and the second air nozzle 72 are arranged in the position near the lower tension roller 12a and 12b, between the lower tension roller 12a and 12b, and the cut-off cylinder 21 and the folding cylinder 22. Then, by blowing air out from these air nozzles 71 and 72, the web 1 is supported on the guide plate 74 and the outer peripheral surface of the folding cylinder 22. The same operational effect as that of the present embodiment may be obtained in the following manner. Specifically, only the first air nozzle 71 is provided while the second air nozzle 72 is omitted. By blowing air out only from the first air nozzle 71, the web 1 is supported on the outer peripheral surface of the folding cylinder 22. However, as in the case of the present embodiment, when both of the first and second air nozzles 71 and 72 are provided, it is possible to more securely prevent, from being tilted, the edge portion of the web 1 on the cut side. For this reason, this configuration is very preferable.

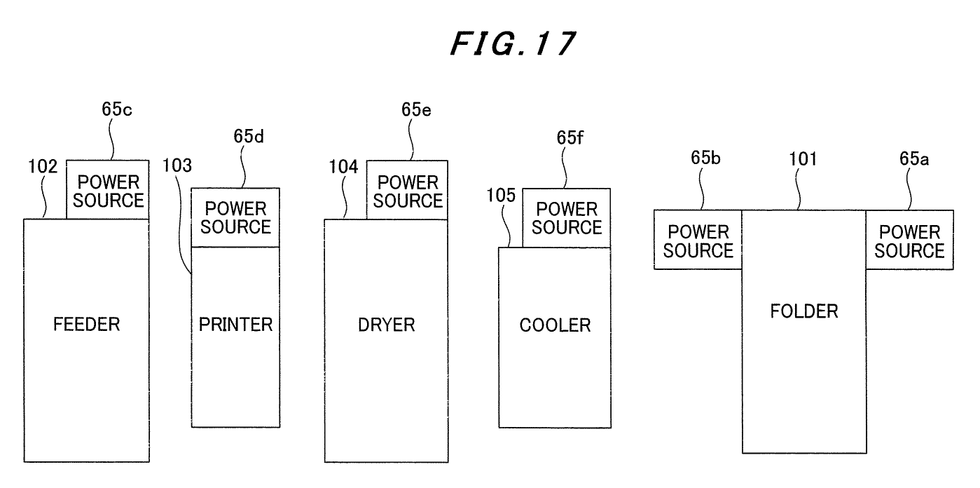

Moreover, in the present embodiment, when the web 1 having a sheet width different from that of the preceding web 1 is spliced, that is, when the new sheet width is selectively inputted (S14), the first and second clutches 62 and 64 are caused to be disengaged, and also the operation of the secondary power source 63 is stopped while the operation of the main power source 61 is activated. Accordingly, the rollers 11a, 12a, and 14a, and the cross-perforation cylinder 13a, and 13b are operated without operating the cylinders 21 to 24, the transporting device 31, the fan wheel 32, and the delivery conveyor 33 (S18 to S28). However, for example, the following configuration is also possible. Specifically, the first clutch 72 is caused to be disengaged, while the second clutch 64 is kept to be engaged without being disengaged. In this state, the operation of the secondary power source 63 is stopped while the operation of the main power source 61 is activated. Accordingly, it is possible to operate the rollers 11a, 12a, and 14a, and the cross-perforation cylinder 13a and 13b without operating the cylinders 21 to 24, the transporting device 31, the fan wheel 32, and the delivery conveyor In addition, in the present embodiment, as shown in FIG. 6, the drive gear 40, the transporting device 31, the fan wheel 32, and the delivery conveyor 33 are connected, via the first clutch 62, to the power transmission system of the main power source 61 for supplying power to the feeder 102, the printer 103, the dryer 104, the cooler 105 and the like, of the printing apparatus. At the same time, the drive gear 40, the transporting device 31, the fan wheel 32, and the delivery conveyor 33 are also connected, via the second clutch 64, to the secondary power source 63 for supplying power to only the drive gear, the transporting device 31, the fan wheel 32, and the delivery conveyor 33. The rollers 11a, 12a, and 14a, the cross-perforation cylinder 13a, and the bearing cylinder 13b are connected to the power transmission system of the main power source 61 in the same manner as that of the feeder 102, the printer 103, the dryer 104, the cooler 105 and the like, of the printing apparatus. In other words, the rollers 11a, 12a, and 14a, the cross-perforation cylinder 13a, and the bearing cylinder 13b are connected directly to the power transmission system of the main power source 61 without the first clutch 62 in between. However, as shown in FIG. 17, a configuration described below is also possible. Specifically, a power source 65a and a power source 65b are provided to the folder 101. The power source 65a supplies power to only the drive gear 40, the transporting device 31, the fan wheel 32, and the delivery conveyor 33, while the power source 65b supplies power to only the rollers 11a, 12a, and 14a, the cross-perforation cylinder 13a, and the bearing cylinder 13b. In addition, power sources 65c to 65f are individually provided respectively to the feeder 102, the printer 103, the dryer 104, the cooler 105 and the like, of the printing apparatus. Accordingly, both synchronized operations and individual operations, of these power sources 65a to 65f, are achieved by controlling means.

Furthermore, in the present embodiment, descriptions have been given of the case where the folding operation is performed by controlling the main power source 61, the secondary power source 63, the clutches 62 and 64, the first-web-cutting means, the second-web-cutting means and the like. However, it is also possible to perform the folding operation by controlling the main power source 61, the first-web-cutting means, the second-web-cutting means and the like. In this case, when the folding specification is changed, the web 1 cut by the cutting knife 17 on the upstream side in the transporting direction continues to be discharged to the discharge side, regardless of the presence or absence of the change in the sheet width. On the other hand, the web 1 on the downstream side in the transporting direction is transported towards the delivery conveyor 33.

In the folder according to the present invention, the first air-blowing means is caused to blow air when the edge portion, on the upstream side in the transporting direction, of the web, which is transported from the web-transporting means, is located at least between the web transporting means and the holding cylinder. For this reason, it is possible to securely support the web between the web transporting means and the holding cylinder on the outer peripheral surface of the holding cylinder. Accordingly, even in the case of the web unbalanced in the width direction, it is possible to prevent the edge side, on the cut side, of the cut web on the downstream side in the feeding direction, from being tilted. As a result, jamming and the like can be prevented.

In the folder according to the present invention, even in the case of web unbalanced in the width direction, it is possible to prevent, from being tilted, the edge portion, on the cut side, of the cut web on the downstream side in the transporting direction. For this reason, it is possible to prevent jamming of paper and the like. Accordingly, the folder may be very effectively utilized in the printing industry, the bookbinding industry and the like.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A folder, comprising:
web-transporting means which transports web;
a rotatable cut-off cylinder which cuts off the web from the web-transporting means;
a rotatable holding cylinder which is arranged so as to face the outer peripheral surface of the cut-off cylinder, and which holds the forward edge side of the web to be cut off by the cut-off cylinder;
first air-blowing means which blows air to the web located between the web-transporting means and the holding cylinder so as to force the web towards the outer peripheral surface of the holding cylinder; and
controlling means which controls the first air-blowing means so that air is blown out from the first air-blowing means to the web when an edge portion of the web, on the upstream side in a transporting direction in which the web is transported, is located at least between the web-transporting means and the holding cylinder.

2. The folder according to claim 1, further comprising:
a first guide member which is arranged so as to be located between the first air-blowing means and the web, and which is capable of guiding the web.

3. The folder according to claim 2, wherein the first guide member includes a hole for causing air from the first air-blowing means to pass through the hole.

4. The folder according to claim 1, wherein the first air-blowing means includes a first air nozzle which is arranged between the web-transporting means and the holding cylinder, and whose opening portion is directed towards the outer peripheral surface of the holding cylinder.

5. The folder according to claim 1, further comprising:
a second guide member which is arranged between the web-transporting means and the holding cylinder, and which guides the web; and
second air-blowing means which blows air to the web located between the web-transporting means and the holding cylinder so as to force the web towards the second guide member side, wherein the controlling means controls the second air-blowing means so that air is blown out from the second air-blowing means to the web when the edge, on the upstream side in the transporting direction, of the web is located at least between the web-transporting means and the holding cylinder.

6. The folder according to claim 5, wherein the second air-blowing means includes a second air nozzle which is arranged between the web-transporting means and the holding cylinder, and whose opening portion is directed towards the second guide member.

7. The folder according to claim 1, further comprising:
web-longitudinally-folding means which is arranged more upstream in the transporting direction of the web than the web-transporting means, and which folds the web along the transporting direction.

8. The folder according to claim 1, further comprising:
web-cutting means which is arranged more upstream in the transporting direction of the web than the cut-off cylinder, and which cuts the web.

9. The folder according to claim 8, wherein the web-cutting means is arranged in the web-transporting means.

10. The folder according to claim 8, wherein an edge portion, on the upstream side in the transporting direction, of the web is an edge portion on the downstream side in the transporting direction, of the web cut by the web-cutting means.

11. The folder according to claim 8, wherein the controlling means controls the first air-blowing means so that the first air-blowing means starts to blow air before the web-cutting means cuts the web.

12. The folder according to claim 1, further comprising:
Signature-transporting means which is arranged more downstream in the transporting direction of the web than the holding cylinder; and
Signature-detecting means which detects the presence or absence of a signature transported by the signature-transporting means,
wherein the controlling means controls, on the basis of a signal from the signature-detecting means, the first air-blowing means so as to stop the blowing of air from the first air-blowing means when there is no more of the signature left.

13. The folder according to claim 1, wherein the web-transporting means includes a plurality of pairs of rollers.

14. The folder according to claim 1, wherein the controlling means controls a cylinder group including the holding cylinder so that the cylinder group corresponds to at least one of a new folding specification and a new sheet width, after an edge portion, on the upstream side in the transporting direction, of the web is transferred from the cylinder group.
